(19) United States
(12) Patent Application Publication
(10) Pub. No.: US 2011/0253877 A1
(43) Pub. Date: Oct. 20, 2011

(54) SYSTEM AND METHOD FOR AN IN-GROUND ARRANGEMENT FOR USE WITH MAILBOXES, SIGNS OR THE LIKE

(76) Inventors: Bruce McCown, Marietta, GA (US); Zamir Syed, Ankeny, IA (US)

(21) Appl. No.: 12/761,485

(22) Filed: Apr. 16, 2010

(51) Int. Cl. F16M 13/00; E02D 7/00

(52) U.S. Cl. 248/548; 405/232

(57) ABSTRACT

A prefabricated concrete pad having embedded anchoring stud assemblies and anchoring tabs for receiving anchoring stakes therethrough. The studs are preferably notched to cause the studs to break-away during higher speed vehicle impact. During lower speed vehicle impact, the studs stay intact and the concrete pad will tilt thereby allowing the mailbox/sign to move thus reducing the potential damage.

### TECHNICAL FIELD

The present invention relates generally to in-ground systems for supporting above-ground display/holding devices and more particularly to an improved system and method for an in-ground arrangement for use with mailboxes, signs and the like.

### BACKGROUND

Throughout the World, a multitude of uses exist requiring the need to display and/or hold objects above ground level. For instance, one of the most common above-ground holding devices is the mailbox post. Another common and widely utilized apparatus is a street sign post. In fact, these two types of general-category above-ground display/holding devices are so commonly utilized that it would be extremely unlikely that any given street in the modern World would not have a multitude of examples. Just focusing on the United States alone, millions of mailboxes and signs are currently in use, and millions more continue to be installed either as new or as replacement for damaged mailboxes/signs.

A large percentage of signs and mailboxes are supported by an above-ground post(s) that is attached to an in-ground securing means. These in-ground securing means typically consist of a weighted anchoring section that is buried sufficiently deep within the ground to provide adequate rigid support. Due to their close proximity to streets and thus moving vehicles, many signs and mailboxes are damaged on a daily basis by vehicle contact. Because of the need for mailboxes and signs to maintain their rigidity and thus fixed position, vehicle contact often results in permanent damage to the above-ground and/or below ground supporting mechanisms of prior-art systems, thus requiring extensive and costly repairs.

More specifically, with most prior-art systems, the sign/mailbox is rigidly attached to a post which in turn is rigidly attached to the in-ground anchoring means. During vehicle contact, depending on the speed and location of the contact, the above-ground support post will often bend or break thus often resulting in permanent damage to the post. In addition, with prior-art systems the in-ground anchoring section is often disturbed and/or damaged during vehicle contact. Whether the damage is only to the post or includes the anchoring system, repair often requires replacement of both the post and the anchoring system, which requires the labor-intensive effort of removing the anchoring system and resetting same in the ground. Consequently, even a minor vehicle impact can result in extensive time-consuming and costly repairs.

Due to the large number of mailboxes and signs that are damaged on a daily basis, the cumulative repair/replacement costs are enormous. Whether these costs are borne by insurance companies, homeowners or vehicle owners, the financial impact is significant. Consequently, there is a need for an improved support means for use with mailboxes and signs that allows the above-ground post to breakaway from the in-ground anchoring means when a vehicle makes contact therewith such that the in-ground anchoring means is not disturbed and wherein, the post can be replaced and reattached to the in-ground anchoring means without the need to remove or disturb the in-ground anchoring means.

### SUMMARY

There is disclosed an improved system and method for an in-ground arrangement having breakaway means for use with mailboxes, signs and the like.

The preferred system embodiment of the present invention comprises a prefabricated concrete pad having embedded anchoring stud assemblies and anchoring tabs for receiving anchoring stakes therethrough. The number and position of anchoring stud assemblies are such that they match the receiving hole pattern of the base of the mailbox/sign post. A plurality of tabs extend from the concrete pad, wherein at least one stake can be driven into the ground and through the tab for providing further support and stability.

Each anchoring stud assembly preferably comprises a stud, a nut, a first washer a second washer, a coupler, a bolt and a third washer. During prefabrication, the bolt and the third washer are formed within the interior of the concrete pad, wherein the coupler is substantially formed within but partially extends beyond the upper surface of the concrete pad. The coupler receives the bolt on its bottom aperture and the stud on the upper aperture. The base of the mailbox/sign post is positioned between the respective first washer and the respective second washer with the nut securing same thereto. The stud is preferably notched to cause the stud to break-away during impact. More specifically, the stud provides sufficient static strength during normal use but during a vehicle impact, the studs will break-away thus reducing the damage to the mailbox/sign. Replacement is substantially simplified over the prior-art method by allowing the simple installation of new replacement studs within the upper aperture of the of the coupler thus allowing the mailbox/sign post base to be reinstalled onto the concrete pad. This method reduces both the costs and time necessary to replace damaged mailboxes/signs. Should the mailbox/sign be hit by a slowly moving vehicle (such as a vehicle backing out of a driveway), the post and entire concrete pad may tilt entirely and pull out of the ground instead of breaking the notched stud. This is advantageous since the same concrete pad and post can be easily reset in the ground thus eliminating the need for a new post or for pouring concrete.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings.

FIG. 1 is a perspective view of a mailbox/sign attached to the in-ground arrangement assembly of the preferred embodiment of the present invention;

FIG. 2 is a side view of a mailbox/sign attached to the in-ground arrangement assembly of the preferred embodiment of the present invention;

FIG. 3 is a perspective view of the in-ground arrangement assembly (showing stakes) of the preferred embodiment of the present invention;

FIG. 4 is a perspective view of the in-ground arrangement assembly of the preferred embodiment of the present invention;

FIG. 5 is top view of the in-ground arrangement assembly of the preferred embodiment of the present invention;

FIG. 6 is side view of the in-ground arrangement assembly of the preferred embodiment of the present invention;

FIG. 7 is a perspective view an anchoring tab of the in-ground arrangement assembly of the preferred embodiment of the present invention;

FIG. 8 is a side view of an anchoring stud assembly of the preferred embodiment of the present invention;

FIG. 9 is a perspective view of an anchoring stud assembly of the preferred embodiment of the present invention;

FIG. 10 is a side view of an anchoring stud assembly of the preferred embodiment of the present invention; and

FIG. 11 is a side view of an anchoring stud assembly of an alternate embodiment of the present invention.

### DETAILED DESCRIPTION OF ILLUSTRATIVE EMBODIMENTS

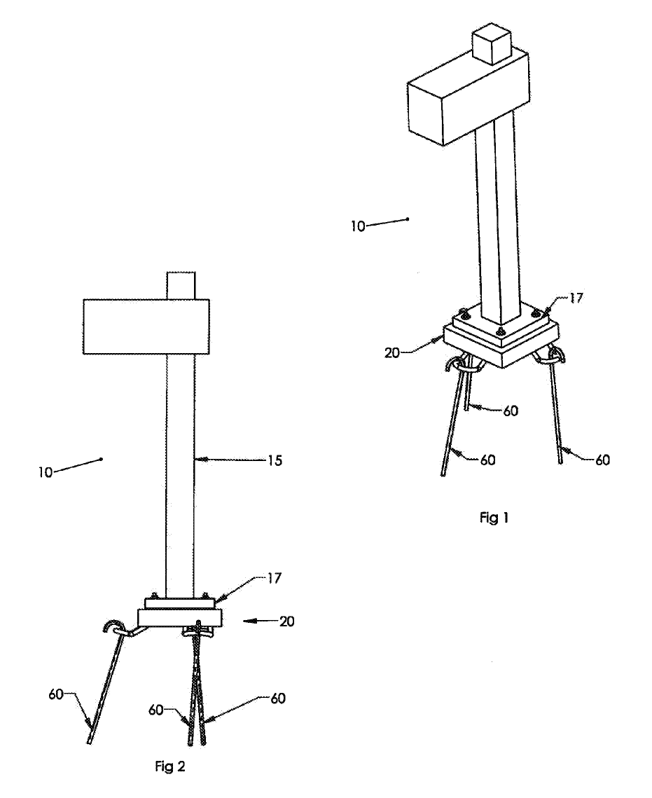

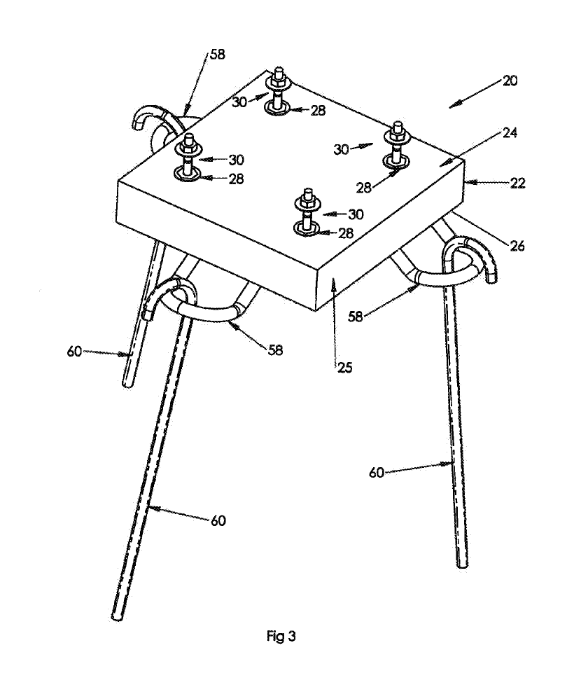

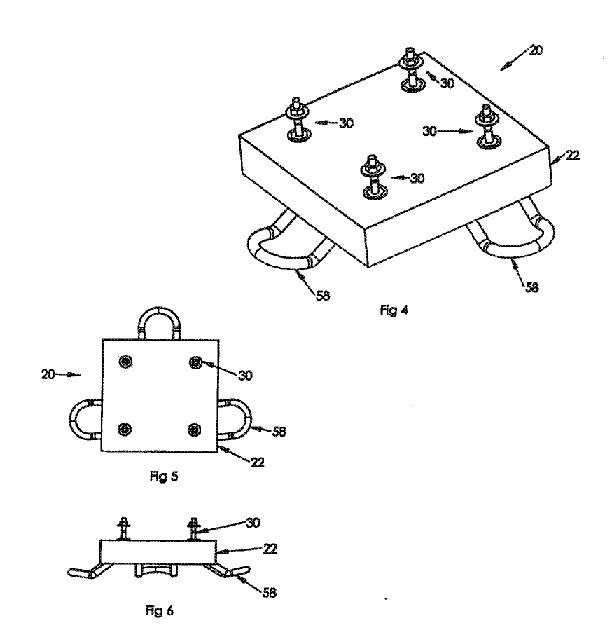

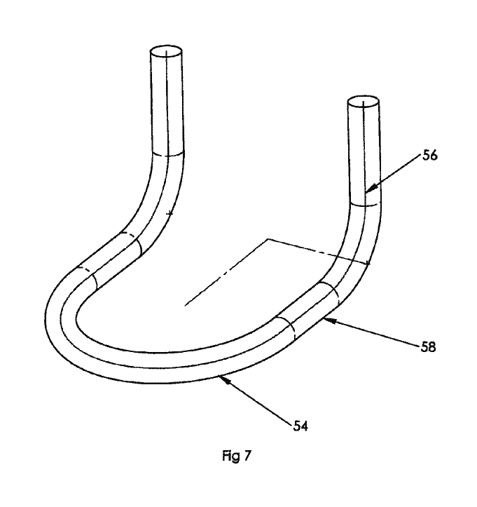

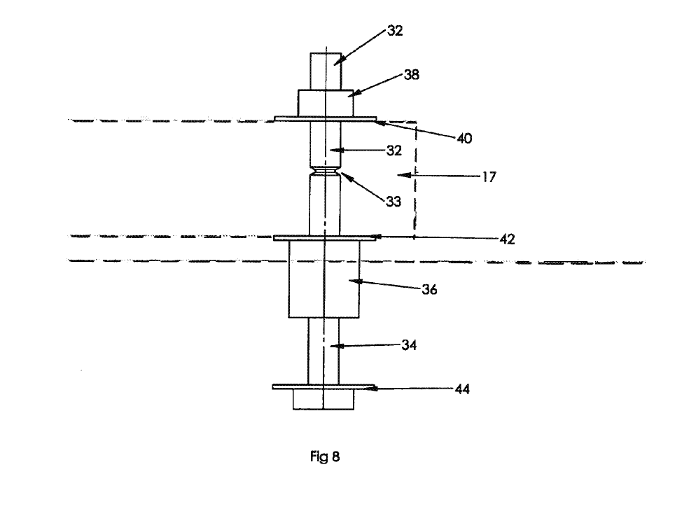

Referring to FIGS. 1-2, there is shown a perspective view of the present invention 10 showing mailbox/sign assembly 15 attached to concrete pad assembly 20 having a plurality of stakes 60. Now referring to FIGS. 3-6, concrete pad assembly 20 generally comprises concrete pad 22, anchor assemblies 30 and tabs 58. Concrete pad 22 is preferably prefabricated off-site (not at the installation site) and is preferably made of concrete to provide a weighted base thus assisting in stabilizing and securing the mailbox/sign assembly 15 in position. Concrete pad 22 has top portion 24, bottom portion 26, side portions 25 and apertures 28. During prefabrication, a mold is utilized to form the preferably square shape, wherein a portion of tabs 58 and anchor assemblies 30 (as more fully described below) are formed such that they are partially embedded within concrete pad 22. Tabs 58 preferably extends out of concrete pad 22 on side portions 25 proximal to bottom portion 26. Although it is preferred that tabs 58 are utilized on 3 sides of a rectangular base, it is contemplated that tabs 58 could be utilized on any number of sides depending on the desired amount of stability, ground work area constraints (such as sidewalks) and shape of the base. The exposed portion of tab 58 is dimensioned for receiving at least one stake 60, wherein stake 60 preferably contains a hook portion that engages tab 58 proximal to portion 54 (See FIG. 7) when stake 60 is driven into the ground. In an additional alternate embodiment, it is contemplated that one or more stakes are embedded within concrete pad 22 and extend downward to allow the top of concrete pad 22 to be forced downward thus driving said stakes into the ground. In an additional alternate embodiment, it is contemplated that holes formed through concrete pad 22 to allow stakes to be driven therethrough for securing said concrete pad 22 in position. In either of these alternate embodiments, any number of tabs 58 may be utilized or not utilized as desired. Tabs 58 may be made out of various materials including, but not limited to, cable/wire, plastic, rebar, steel, aluminum or composite. Anchor assemblies 30 extend upward from top portion 24 and are positioned and dimensioned to match the hole pattern of the applicable mailbox/sign post base.

Please note that although the preferred pad is described as being made from concrete, it is understood that in alternate embodiments, the pad could be made from a multitude of weighted materials such as metals, plastics, composites, natural rock, minerals or a combination thereof.

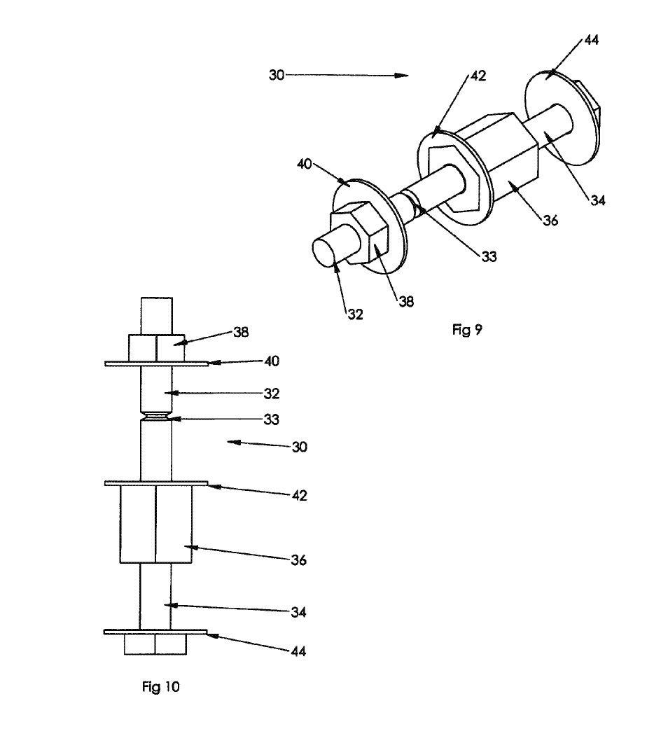

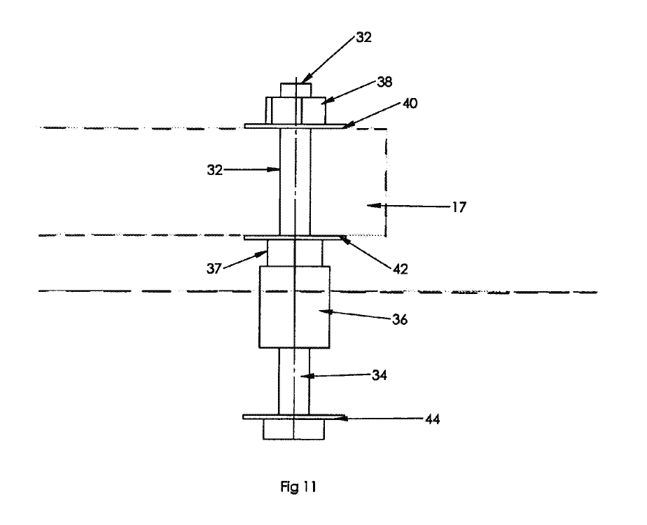

Now referring to FIGS. 8-10, each anchor assembly 30 preferably comprises stud 32, bolt 34, coupler 36, nut 38, first washer 40, second washer 42 and third washer 44. During prefabrication and forming of concrete pad 22, bolts 34, washer 44 and couplers 36 are embedded therein. Various templates having different hole patterns can be utilized to ensure proper coupler 36 spacing and to hold the embedded hardware consisting, in a preferred embodiment, of couplers 36, bolts and washers. Each coupler 36 preferably extends above top portion 24 of concrete pad 22 by approximately ¼ of an inch. Each coupler 36 is preferably threaded to receive bolt 34 and stud 32 on opposite ends. Although threaded stud 32 is the preferred method connecting means, it is contemplated that other known connection methods such as a bolt and/or one-way tongue and groove locking mechanism or any other known methods may be utilized.

Now referring to FIG. 11, an alternate embodiment of the anchor assembly 30 is shown, wherein stud 32 is a glass-filled nylon stud. Nut 37 is used between coupler 36 and second washer 42 to assist in setting the location of the breakage to assure that it is not flush with the top of the coupler. This aids in removal and replacement of stud 32. To improve the reliability of the breakaway location on the glass filled nylon stud 32, an expansion type adhesive can be utilized to provide a small amount of additional tensile strength to the coupler-nut interface, thereby, reducing the likelihood of failure at that particular undesirable location.

During installation, the holes pattern in the mailbox/sign post base 17 is matched with the each extending stud 32, wherein mailbox/sign post base 17 rest on top of second washer 42. Next, first washers 40 are placed around each stud 32 and thus rests on top of mailbox/sign post base 17. Each nut 38 is then placed on threaded stud 23 and tightened to secure mailbox/sign post base 17 to concrete pad assembly 20.

Each stud 32 is preferably notched proximal to its longitudinal center to provide the breakaway characteristics. The preferred form of notching is the use of a 360 degree notch 33 around stud 32 at approximately a middle longitudinal position, wherein said notch is approximately 20-30% through, with 25% being the preferred amount. At 25% 360 degree notching, the minimum break-away force is approximately 550 lbs assuming grade 2 steel studs. This is the preferred amount of force so as to allow enough static strength to prevent premature break-away during installation and use but yet, break-away at a low enough force to reduce the amount and severity of damage to the mailbox/sign during impact. Although a 360 degree notch method is the preferred method, it is also contemplated that a single notch between 30%-60% or a double notch between 25-30% may be utilized in alternate embodiments. It is also contemplated in other alternate embodiments that differing materials may be utilized in lieu of notching. For instance, in one alternate embodiment, glass filled nylon is contemplated wherein the break-away force is sufficient without notching to accomplish the same goal.

As a result of the present invention, when a mailbox/sign is impacted by a vehicle at higher speeds, stud 32 breaks away thereby allowing the mailbox/sign to simply fall to the ground thus reducing damage to the mailbox/sign and its post. Consequently, replacement/reinstallation costs are reduced and replacement/reinstallation efforts are significantly improved. The installer simply replaces studs 32 and then resets the mailbox/sign base thereon as described above. At higher impact speeds, the in ground concrete pad 22 remains intack thus eliminating the need for redigging and/or replacement of the base and/or posts. At lower impact speeds, the force may be such that studs 32 do not break away but instead the in-ground concrete pad 22 is pulled out of the ground thereby allowing the mailbox/sign to tilt and/or fall, and thus, preventing destructive damage to the mailbox/sign. The assembly can then be easily reinstalled by resetting concrete pad 22 in the ground as described above.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed:

1. A method of providing a break-away arrangement for holding a sign, mailbox or the like having a base with a plurality of holes, comprising the steps of:
a) prefabricating an anchoring pad, wherein said anchoring pad comprises a plurality of studs and couplers, and wherein said studs are preselected to have a predetermined tensile strength, and wherein said couplers are embedded within said anchoring pad and said studs engage with said couplers;
b) leveling an area for receiving said anchoring base;
c) placing said anchoring pad on said leveled area;
d) placing the base of the sign, mailbox or the like on said anchoring pad such that said studs mate with and extend through the holes of the base of the sign, mailbox or the like;
e) securing the base to said anchoring pad, wherein when a sufficient force is applied to the sign, mailbox or the like, said studs will break, and wherein said broken studs can be replaced with new studs and steps d and e and be repeated to reinstall the sign, mailbox or the like.

2. The method of claim 1, further comprising the step of covering the top and sides of said anchoring base with dirt and compacting same to assist in stabilizing same.

3. The method of claim 1, wherein step a, further comprises the use of tabs and spikes to secure said anchoring base in position.

4. An arrangement for securing a sign, mailbox or the like in position, comprising:
a) an anchoring pad having a plurality of studs and a plurality of at least partially embedded couplers; and
b) a sign, mailbox or the like having a post and a base, wherein said base has a plurality of holes extending therethrough, and wherein said studs are alignable with and extendable through said holes of said pad.

5. The arrangement of claim 4, further comprising a plurality of anchoring tabs carried by said anchoring pad and a plurality of anchoring stakes.

6. The arrangement of claim 4, wherein said studs are notched on at least one side to reduce the tensile strength thereof

7. The arrangement of claim 4, wherein said studs are notched 360 degrees to reduce the tensile strength thereof.

8. The arrangement of claim 4, wherein said studs comprise glass-filled nylon.

9. The arrangement of claim 4, wherein said couplers are substantially embedded within said anchoring pad.

10. A method of making a break-away arrangement for holding a sign, mailbox or the like, comprising the steps of:
a) obtaining a mold;
b) using a template for positioning and holding a plurality of couplers and studs within said mold;
c) pouring a solidifying material into said mold and allowing said material to solidify to form an anchoring pad; and
d) removing said anchoring pad for installation on site.

11. The method of claim 10, wherein said mold is generally square.

12. The method of claim 10, wherein said studs comprise at least one notch.

13. The method of claim 10, further comprising the step of positioning a plurality of anchoring tabs within said mold.

14. The method of claim 12, further comprising the use of a plurality of stakes dimensioned to be received through said anchoring tabs.

15. The method of claim 1, wherein when the force in step e is not sufficient to cause said studs to break, said anchoring pad is tilted thus allowing the sign, mailbox or the like to be tilted to reduce the potential damage thereto.

16. The method of claim 1, wherein at least one stake is embedded into said anchoring pad, wherein said at least one stake can be driven into the ground for further securing of said anchoring pad

17. The arrangement of claim 4, further comprising at least one stake embedded into said anchoring pad, wherein said at least one stake can be driven into the ground for further securing of said anchoring pad.
